(19) United States
(12) Patent Application Publication
(10) Pub. No.: US 2011/0180014 A1
(43) Pub. Date: Jul. 28, 2011

(54) DOG RING / RING-GO SYSTEMS

(76) Inventor: David Wilder, Colorado Springs, CO (US)

(21) Appl. No.: 13/014,279

(22) Filed: Jan. 26, 2011

Related U.S. Application Data
(60) Provisional application No. 61/298,621, filed on Jan. 27, 2010.

(51) Int. Cl. A01K 1/06; A01K 1/064; A01K 1/04

(52) U.S. Cl. 119/784; 119/795; 119/788

(57) ABSTRACT

A tangle-free portable animal tethering device comprising a first ring with an outer circumference having a hinge and a locking mechanism, and a leash fastening member. The first ring is secured around a periphery of a cylindrical post via opening and closing the locking mechanism. The hinge is situated opposing the locking mechanism and the first ring is foldable about the hinge for ease of transport and storage. The leash fastening member may slide freely in relation to the first ring during in-use periods, and a leash may be secured to the leash fastening member allowing an animal to be tethered to the cylindrical post.

### CROSS-REFERENCE TO RELATED APPLICATION

The present application is related to and claims priority from prior provisional application Ser. No. 61/298,621, filed Jan. 27, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of pet restraint devices and more specifically relates to a tangle-free and portable animal tethering device.

2. Description of the Related Art

Since many dog owners do not have a fenced-in yard, it is oftentimes desired to keep an animal tethered to a fixed point with a restraint so as to prevent the animal from getting lost or injured. For example, in a yard with no fence, it may be desired to tether the animal to keep it from running off the property. Oftentimes a stake or pole in the ground with a tether attached to it can serve this purpose. The animal restraint can be tied to the tether to keep the animal within a defined area.

However, many animals may get entangled with a fixed tether. Currently available tethering devices may become entangled resulting in discomfort and a potentially dangerous situation developing for the tethered animal Animals may be entrapped for a long time if the owner does not observe the animal or is not at home. Dogs in particular may become wound around poles and may be unable to free themselves. In addition, many pet restraint devices are heavy and bulky and are therefore not easy to transport.

Therefore a need exists for an improved tethering device so as to prevent a dog from becoming entangled by its leash resulting in physical injury. A further need exists for a tangle-free, lightweight pet restraint device which is easy to transport.

Various attempts have been made to solve the above-mentioned problems such as those found in U.S. Pat. Nos. 5,971,668; 6,435,137; 4,334,503; 6,612,263; 6,374,777; and 5,031,577. This prior art is representative of pet restraint devices. None of the above inventions and patents, taken either singly or in combination, is seen to describe the invention as claimed.

Ideally, a pet restraint device should be easy to install, lightweight, easy to transport, operate reliably, prevent an animal from becoming entangled, and be manufactured at a modest expense. Thus, a need exists for a reliable Dog Ring/ Ring Go System to prevent an animal from becoming entangled and to avoid the above-mentioned problems.

### BRIEF SUMMARY OF THE INVENTION

In view of the foregoing disadvantages inherent in the known pet restraint devices art, the present invention provides a novel Dog Ring/Ring Go System. The general purpose of the present invention, which will be described subsequently in greater detail, is to provide a tangle-free, lightweight pet restraint device which is easy to transport.

The present tangle-free portable animal tethering device disclosed herein preferably comprises the following components: a first ring with an outer circumference having a hinge and a locking mechanism, and a leash fastening member.

The first ring is secured around a periphery of a cylindrical post via opening and closing the locking mechanism. The locking mechanism comprises a male end which is inserted into a female end and is open-able by pressing two small push buttons located on the female end. The hinge is situated opposing the locking mechanism and the first ring is foldable about the hinge for ease of transport and storage. The leash fastening member may comprise a second ring which may slide freely in relation to the first ring during in-use periods. Further, a leash may be secured to the leash fastening member allowing an animal to be tethered to the cylindrical post.

A kit is embodied herein for the Dog Ring/Ring Go System comprising: at least one first ring, at least one leash fastening member, and a user instruction manual.

In accordance with the embodiments of the present invention a preferred method of use is disclosed herein comprising: removably securing a first ring around or to a tree, post or stationary object via opening and closing a locking mechanism of the first ring, attaching a leash to a leash fastening member which slides freely along an outer circumference of the first ring, attaching the leash to a collar of an animal so as to enable the animal to freely move within a defined area avoiding risk of entanglement, detaching the leash from the leash fastening member, removing the first ring from the stationary object via opening the locking mechanism of the first ring, and optionally folding the unlocked ring about a hinge of the first ring, transporting the tangle-free portable animal tethering device between locations, and storing the tangle-free portable animal tethering device.

The present invention holds significant improvements and serves as a Dog Ring/Ring Go System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Dog Ring/Ring Go Systems, constructed and operative according to the teachings of the present invention.

FIG. 1 shows a perspective view illustrating a tangle-free portable animal tethering device in an ‘in-use’ condition according to an embodiment of the present invention.

FIG. 2 is a perspective view illustrating the tangle-free portable animal tethering device according to an embodiment of the present invention of FIG. 1.

FIG. 3 is a perspective view illustrating the tangle-free portable animal tethering device according to an alternative embodiment of the present invention of FIGS. 1 and 2.

FIG. 4 is a perspective view illustrating the tangle-free portable animal tethering device according to an alternative embodiment of the present invention of FIGS. 1-3.

FIG. 5 is a flowchart illustrating a method of using the tangle-free portable animal tethering device according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a pet restraint device and more particularly to a tangle-free portable animal tethering device as used to prevent an animal from becoming entangled by its leash resulting in physical injury and/or the animal not being able to have enough movement and/or slack in the tangle-free portable animal tethering device to reach their food and/or water.

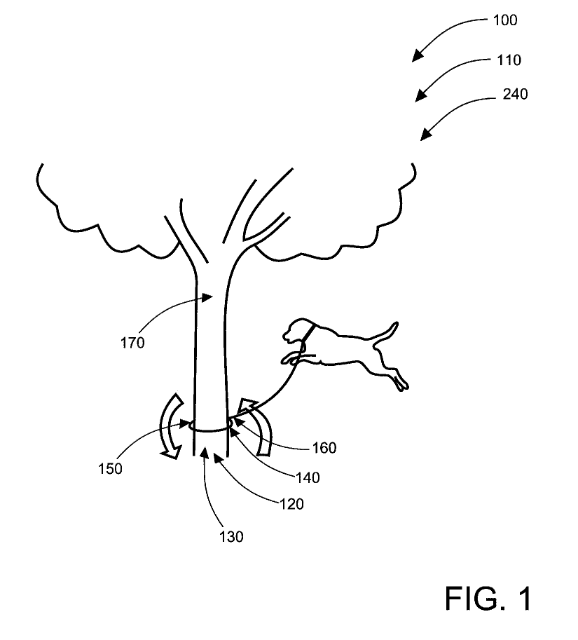

Referring to the drawings by numerals of reference there is shown in FIG. 1, a perspective view illustrating tangle-free portable animal tethering device 110 in ‘in-use’ condition 240 according to an embodiment of the present invention.

Tangle-free portable animal tethering device 110 preferably comprises first ring 120 comprising outer circumference 130, hinge 140 and locking mechanism 150, and leash fastening member 160.

First ring 120 is secured around a periphery of cylindrical post 170 via opening and closing locking mechanism 150. Hinge 140 is situated opposing locking mechanism 150 and first ring 120 is preferably foldable about hinge 140 for ease of transport and storage. However, it should be noted that first ring 120 does not have to be foldable about hinge 140, and may not comprise hinge 140. Leash fastening member 160 may comprise a second ring 180 which may slide freely in relation to first ring 120 during in-use periods. Further, a user may secure a leash to leash fastening member 160 thereby allowing an animal to be tethered to cylindrical post 170 and creating ‘in-use’ condition 240.

Since second ring 180 may slide freely in relation to first ring 120 during ‘in-use’ periods, tangle-free portable animal tethering device 110 prevents an animal from becoming entangled by its leash which may result in physical injury or discomfort. The animal may roam freely within a defined area without risk of entanglement.

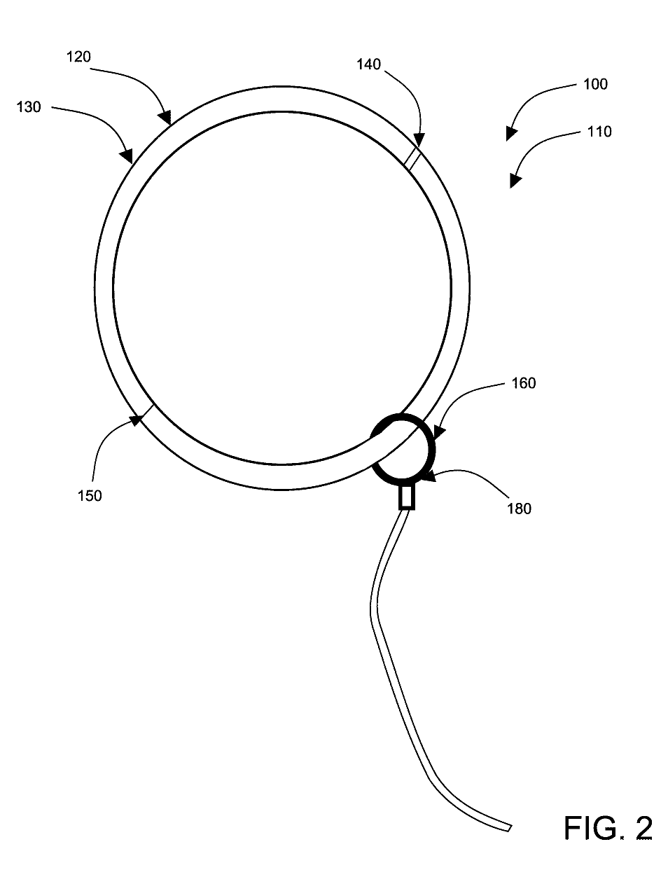

Referring now to FIG. 2, showing a perspective view illustrating tangle-free portable animal tethering device 110 according to an embodiment of the present invention of FIG. 1.

As mentioned previously, tangle-free portable animal tethering device 110 preferably comprises first ring 120 comprising outer circumference 130, hinge 140 and locking mechanism 150, and leash fastening member 160.

First ring 120 preferably comprises an inner diameter and an outer circumference 130. Inner diameter of first ring 120 comprises a greater diameter than a diameter of cylindrical post 170, tree or other suitable stationary object, so that first ring 120 may easily be secured around a periphery of cylindrical post 170, around a tree, or other suitable stationary object. First ring 120 preferably comprises a tubular shape and a smooth surface. First ring 120 may preferably comprise stainless steel. However, first ring 120 may comprise any kind of suitable and durable material, such as corrosion-resistant metal or plastic.

First ring 120 further comprises locking mechanism 150. First ring may be secured around a periphery of cylindrical post 170 by opening and closing locking mechanism 150. Locking mechanism 150 preferably comprises a male end which is inserted into a female end and is open-able by pressing two small push buttons located on the female end. However, locking mechanism 150 may comprise any kind of suitable and durable closing mechanism, which preserves the surface of first ring 120 in a smooth and unobstructed condition.

First ring 120 comprises hinge 140 which is situated opposing locking mechanism 150. First ring 120 is foldable about hinge 140 for ease of transport and storage. User may open locking mechanism 150 and fold the unlocked first ring 120 about hinge 140 of first ring 120. User may now easily transport tangle-free portable animal tethering device 110 between locations and store tangle-free portable animal tethering device 110.

Tangle-free portable animal tethering device 110 further comprises leash fastening member 160. Leash fastening member 160 may comprise second ring 180 with a smaller diameter than first ring 120 which may travel about the outer circumference 130 of first ring 120. Second ring 180 is preferably made of stainless steel and comprises a smooth surface so second ring 180 may slide about outer circumference 130 of first ring 120 without obstruction. However, second ring 180 may be made of any durable material with a smooth surface, such as any corrosion-resistant metal or plastic. A leash may be removably attached to second ring 180 and to the collar of an animal so as to secure the animal. Since second ring 180 may slide about the outer circumference 130 of first ring 120 without obstruction, the animal may move freely within a defined area without any risk of entanglement. Tangle-free portable animal tethering device 110 may be used for various types of animals, such as dogs, cats, horses or other domesticated animals.

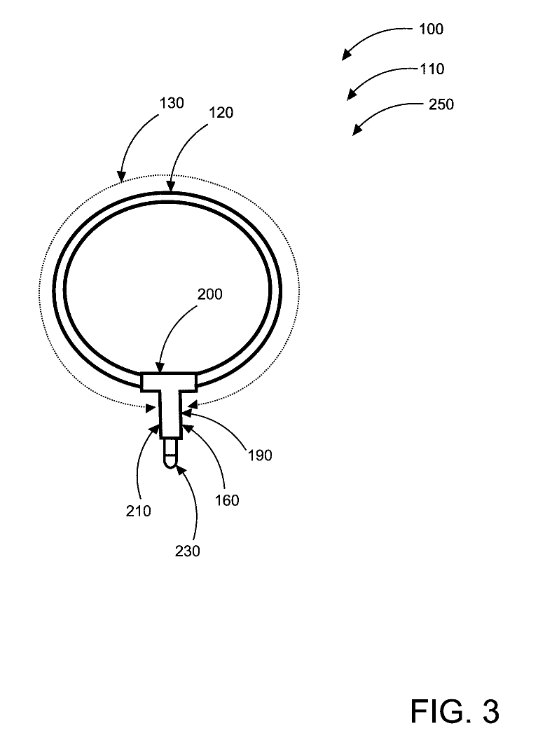

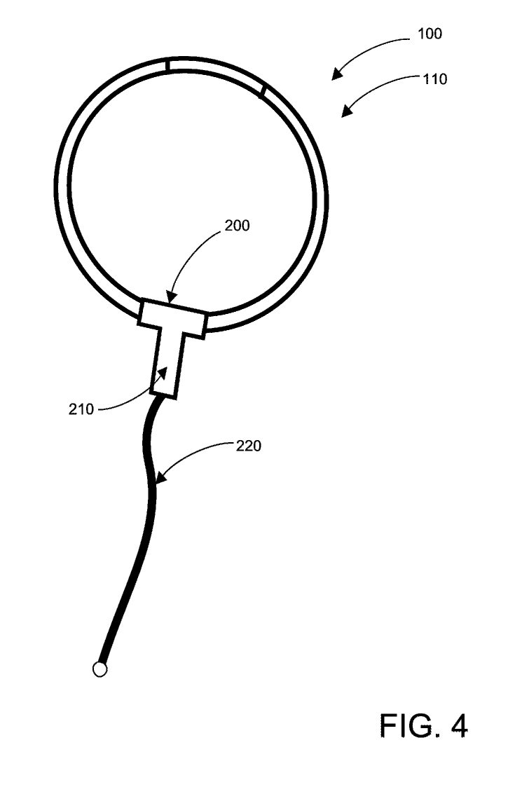

Referring now to FIGS. 3 and 4, showing perspective views illustrating tangle-free portable animal tethering device 110 according to an alternative embodiment of the present invention of FIGS. 1 and 2.

In an alternative embodiment, leash fastening member 160 may comprise T-shaped member 190. T-shaped member preferably comprises short side 200 and long side 210. Short side 200 comprises a hollow tube which is preferably made of corrosion-resistant material and which may slide freely about outer circumference 130 of first ring 120. Long side 210 which is also preferably made of corrosion-resistant material may house retractable leash 220, as depicted in FIG. 4, which may be attached to the collar of an animal so as to secure the animal. Since short side 200 may slide about the outer circumference 130 of first ring 120 without obstruction and the leash retracts as the animal comes closer to the cylindrical post 170, the animal may move freely within a defined area without risk of entanglement. Alternatively, long side 210 may comprise attacher 230 for a leash, such as a hook or karabiner, as depicted in FIG. 3.

Dog Ring/Ring Go Systems 100 may be sold as kit 250 comprising the following parts: at least one first ring 120, at least one leash fastening member 160, and at least one set of user instructions.

Dog Ring/Ring Go Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

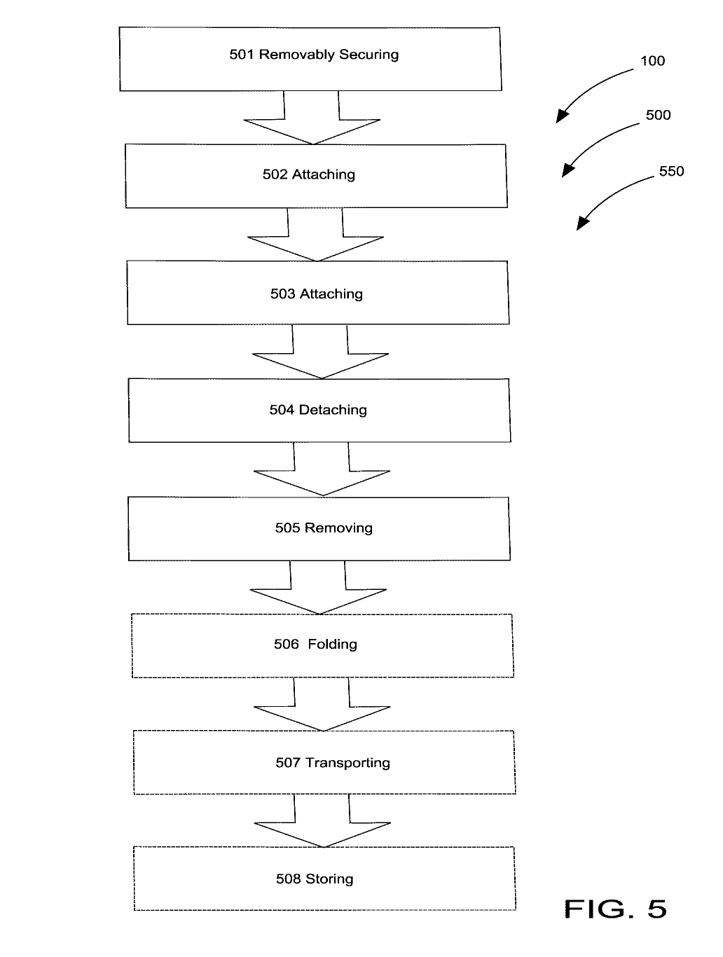

Referring now to FIG. 5, a flowchart 550 illustrating a method 500 of using the tangle-free portable animal tethering device 110 according to an embodiment of the present invention of FIGS. 1-4.

In accordance with the embodiments of the present invention a preferred method of use 500 is disclosed herein comprising: step one 501 removably securing a first ring around or to a tree, post or stationary object via opening and closing a locking mechanism of the first ring; step two 502 attaching a leash to a leash fastening member which slides freely along an outer circumference of the first ring; step three 503 attaching the leash to a collar of an animal so as to enable the animal to freely move within a defined area avoiding risk of entanglement; step four 504 detaching the leash from the leash fastening member; step five 505 removing the first ring from the stationary object via opening the locking mechanism of the first ring; step six 506 folding the unlocked ring about a hinge of the first ring; step seven 507 transporting the tangle-free portable animal tethering device between locations; and step eight 508 storing the tangle-free portable animal tethering device.

It should be noted that steps 506-508 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A tangle-free portable animal tethering device comprising:
a first ring with an outer circumference having a hinge and a locking mechanism; and
a leash fastening member;
wherein said first ring is secured around a periphery of a cylindrical post via opening and closing said locking mechanism;
wherein said hinge is situated opposing said locking mechanism and said first ring is foldable about said hinge for ease of transport and storage;
wherein said leash fastening member may slide freely in relation to said first ring during in-use periods; and
wherein a leash may be secured to said leash fastening member allowing an animal to be tethered to said cylindrical post.

2. The tangle-free portable animal tethering device of claim 1 wherein said first ring comprises corrosion-resistant material.

3. The tangle-free portable animal tethering device of claim 1 wherein said first ring comprises stainless steel.

4. The tangle-free portable animal tethering device of claim 1 wherein said first ring comprises plastic.

5. The tangle-free portable animal tethering device of claim 1 wherein said locking mechanism comprises a male end which is inserted into a female end and is openable by pressing two small push buttons located on said female end.

6. The tangle-free portable animal tethering device of claim 1 wherein said leash fastening member comprises a second ring.

7. The tangle-free portable animal tethering device of claim 6 wherein said second ring travels about said outer circumference of said first ring.

8. The tangle-free portable animal tethering device of claim 7 wherein said second ring comprises stainless steel.

9. The tangle-free portable animal tethering device of claim 1 wherein said leash fastening member comprises a T-shaped member with a short side and a long side, said short side comprising a hollow tube which may slide freely about said outer circumference of said first ring.

10. The tangle-free portable animal tethering device of claim 9 wherein said long side houses a retractable leash.

11. The tangle-free portable animal tethering device of claim 9 wherein said long side connects to a non-retractable leash.

12. The tangle-free portable animal tethering device of claim 9 wherein said leash fastening member comprises corrosion-resistant material.

13. The tangle-free portable animal tethering device of claim 1 wherein said cylindrical post comprises a tree.

14. The tangle-free portable animal tethering device of claim 1 wherein an inner diameter of said first ring comprises a greater diameter than an outer diameter of said cylindrical post.

15. A tangle-free portable animal tethering device comprising:
a stainless steel first ring with an outer circumference having a hinge and a locking mechanism, which is secured around or to a tree, post or stationary object via opening and closing said locking mechanism, said locking mechanism comprising a male end which is inserted into a female end and which is open-able by pressing two small push buttons located on said female end; and
a leash fastening member comprising a corrosion-resistant T-shaped member with a short side and a long side, said short side comprising a hollow tube which may slide freely about said outer circumference of said stainless steel first ring and said long side housing a retractable leash;
wherein said hinge is situated across from said locking mechanism and said stainless steel first ring may fold at said hinge for ease of transport and storage.

16. The tangle-free portable animal tethering device of claim 15 wherein said tangle-free and portable animal tethering device further comprises a kit including said at least one first ring, said at least one leash fastening member, and a user instruction manual.

17. A method of using a tangle-free portable animal tethering device comprising the steps of:
removably securing a first ring around or to a tree, post or stationary object via opening and closing a locking mechanism of said first ring;
attaching a leash to a leash fastening member which slides freely along an outer circumference of said first ring;
attaching said leash to a collar of an animal so as to enable said animal to freely move within a defined area avoiding risk of entanglement;
detaching said leash from said leash fastening member; and
removing said first ring from said stationary object via opening said locking mechanism of said first ring.

18. The method of claim 17 further comprising the steps of:
folding said unlocked ring about a hinge of said first ring;
transporting said tangle-free portable animal tethering device between locations; and
storing said tangle-free portable animal tethering device.
